(19) United States
(12) Patent Application Publication
(10) Pub. No.: US 2024/0264957 A1
(43) Pub. Date: Aug. 8, 2024

(54) STORAGE-INTEGRATED MEMORY EXPANDER, COMPUTING SYSTEM BASED COMPUTE EXPRESS LINK, AND OPERATING METHOD THEREOF

(71) Applicant: KOREA ADVANCED INSTITUTE OF SCIENCE AND TECHNOLOGY, Daejeon (KR)

(72) Inventors: Myoungsoo JUNG, Daejeon (KR); Donghyun GOUK, Daejeon (KR); Miryeong KWON, Daejeon (KR)

(21) Appl. No.: 18/425,079

(22) Filed: Jan. 29, 2024

(30) Foreign Application Priority Data
Feb. 3, 2023 (KR) 10-2023-0015012

(51) Int. Cl. G06F 13/16; G06F 12/02; G06F 13/42

(52) U.S. Cl. CPC G06F 13/1673; G06F 12/0246; G06F 13/4221

(57) ABSTRACT

A compute express link (CXL) computing system includes a host device including a CPU that supports CXL, and a CXL storage connected to a CXL root port of the CPU based on the CXL interconnect and including a flash memory-based memory module.

### CROSS-REFERENCE TO RELATED APPLICATION

This application claims priority to and the benefit of Korean Patent Application No. 10-2023-0015012 filed in the Korean Intellectual Property Office on Feb. 3, 2023, the entire contents of which are incorporated herein by reference.

### BACKGROUND

### (a) Field

The present disclosure relates to memory expansion.

### (b) Description of the Related Art

One may enable a peripheral component interconnect express (PCIe) storage to be accessed in unit of bytes (byte-addressability), allowing users to leverage the storage as a memory expander. In accordance to non-volatile memory express (NVMe) standard, such byte addressability may be implemented by exposing the internal memory/buffer of a solid-state drive SSD) to PCIe base address registers (BARs). Since BARs can be directly mapped to the system memory space, the host-side kernel and applications may access the memory/buffer of the SSD just like the local memory (using load/store instructions) rather than a block device.

Unfortunately, while PCIe can provide sufficient bandwidth for such usage scenario, the device may exhibit limited performance, making it impractical to be used in real system. A device connected through PCIe should be managed as a peripheral device by communicating with the host CPU. This prevents caching the load/store instructions given from the host CPU to BARs of the PCIe device, unlike the local dynamic random access memory (DRAM). Such a non-cacheable characteristics significantly degrades the performance of memory access heading to BARs. In conclusion, while the non-cacheable characteristic of PCIe address space (e.g., BARs) is essential for managing the system, such characteristic introduces significant slowdown that hinders leveraging block storage device as a byte-addressable memory expander.

### SUMMARY

The present disclosure attempts to provide a storage-integrated memory expander, a compute express link (CXL) computing system including the same, and an operating method thereof.

According to an embodiment, a compute express link (CXL) computing system includes a host device including a CPU that supports CXL, and a CXL storage connected to a CXL root port of the CPU based on CXL interconnect and including a flash memory-based memory module.

The memory module may be a host-managed device memory (HDM) and mapped to a cacheable memory address space that is accessed by load/store instructions in the host device.

The CXL storage may be a type 3 CXL device that supports CXL.io protocol and CXL.mem protocol.

The CXL root port may include a packet transmission function of CXL protocol.

The CXL storage may include a CXL controller, a flash memory controller, an internal memory, and the flash memory-based memory module.

The CXL controller may include a read/write interface of CXL.mem protocol.

The CXL controller may be implemented in a conversion device separate from the storage including the flash memory controller and the memory module, and the conversion device may connect the host device and the storage based on the CXL.

The host device and the CXL storage may be connected through a CXL switch. The CXL switch may route CXL flits incoming to an upstream port or a downstream port to the corresponding port according to an internal routing table.

The host device may access a host-managed device memory (HDM) through a cache, and when a cache miss occurs, convert a memory request into a CXL flit and transmit the CXL flit to the CXL storage.

The CXL flit may include a hint instructing the CXL storage to perform an operation related to the memory request.

According to another embodiment, a memory expander includes a compute express link (CXL) controller including an end point connected to a CXL root port based on a CXL and parsing a memory request from a received CXL flit, a flash memory-based memory module, and a flash memory controller controlling the memory module according to the memory request transmitted from the CXL controller.

The CXL controller may support CXL.io protocol and CXL.mem protocol.

The CXL controller may include a read/write interface of the CXL.mem protocol.

The memory module may be a host-managed device memory (HDM) and mapped to a cacheable memory address space that is accessed by load/store instructions in a host.

The CXL flit may include a hint instructing an operation related to the memory request.

When a request including a hint called deterministic (DT) arrives, the flash memory controller may delay other internal tasks, and first process the corresponding request.

When a request including a hint called bufferable (BF) arrives, the flash memory controller may cache or buffer the corresponding request in an internal memory, and when a request including a hint called non-bufferable (NB) arrives, perform an operation of preferentially ensuring data persistency.

According to still another embodiment, an operating method of a host device supporting a compute express link (CXL) includes mapping a memory module of a CXL storage to a cacheable memory address space that is accessed by load/store instructions and managing the memory module as a host-managed device memory (HDM), accessing the HDM through a cache for a memory request including the load/store instructions, and converting the memory request into a CXL flit when a cache miss occurs and transmitting the CXL flit to the CXL storage.

The CXL flit may include a hint instructing the CXL storage to perform an operation related to the memory request.

The hint may instruct to process the corresponding request before other internal tasks, cache or buffer the corresponding request in the internal memory of the CXL storage, or instruct to preferentially ensure data persistency for the corresponding request.

According to the present disclosure, the storage such as SSD can be used as the cacheable memory expander, improving the performance of a wide range of applications requiring a large-capacity memory, such as large-scale scientific analysis, healthcare, recommendation systems, and machine learning-based autonomous vehicle.

### BRIEF DESCRIPTION OF THE DRAWINGS

FIGS. 1 and 2 are diagrams illustrating a structure of a computing system according to an embodiment.

FIG. 3 is a diagram illustrating a structure of a CXL computing system according to an embodiment.

FIG. 4 is a diagram illustrating a computing system that provides a CXL-based byte-addressability according to an embodiment.

FIG. 5 is a diagram for describing cacheable access according to an embodiment.

FIG. 6 is a diagram for describing a structure of a CXL-supported host device and CXL storage according to an embodiment.

FIGS. 7 and 8 each are flow diagrams of a cacheable-based memory access method according to an embodiment.

FIGS. 9 to 11 each are diagrams illustrating a storage distribution system according to an embodiment.

FIG. 12 is a diagram for describing a storage control method according to an embodiment.

FIG. 13 is an example of storage control according to an embodiment.

FIG. 14 is a flowchart of the storage control method according to the embodiment.

FIG. 15 is a diagram for describing a CXL-SSD switch according to an embodiment.

### DETAILED DESCRIPTION OF THE EMBODIMENTS

Hereinafter, embodiments of the present disclosure will be described in detail with reference to the accompanying drawings so that those skilled in the art to which the present disclosure pertains may easily practice the present disclosure. However, the present disclosure may be modified in various different forms, and is not limited to embodiments provided herein. In addition, components unrelated to a description will be omitted in the accompanying drawings in order to clearly describe the present disclosure, and similar reference numerals will be used to denote similar components throughout the present specification.

In the description, reference numerals and names are added for convenience of description, and the devices are not necessarily limited to the reference numerals or names.

In description, in addition, unless explicitly described to the contrary, the word “comprise”, and variations such as “comprises” or “comprising”, will be understood to imply the inclusion of stated elements but not the exclusion of any other elements. In addition, the terms “-er”, “-or”, and “module” described in the specification mean units for processing at least one function and operation, and can be implemented by hardware components or software components, and combinations thereof.

In description, in addition, an expression written in singular may be construed in singular or plural unless an explicit expression such as “one” or “single” is used. Terms including an ordinal number such as first, second, etc., may be used to describe various components, but the components are not limited to these terms. The above terms are used solely for the purpose of distinguishing one component from another.

In flowcharts described with reference to the drawings, an order of operations may be changed, several operations may be merged, some operations may be divided, and specific operations may not be performed.

A block storage or a block device is a non-volatile storage that does not lose stored data even when a power supply is turned off, such as a flash memory, and stores and erase data in units of blocks. In the following, a solid-state drive (SSD) is explained as an example of the block storage, but it is not limited thereto. A system memory, such as a dynamic random-access memory (DRAM), is a volatile memory in which stored data is lost when the power supply is turned off, and may allow addresses to be specified in units of bytes and have faster speed than the block storage.

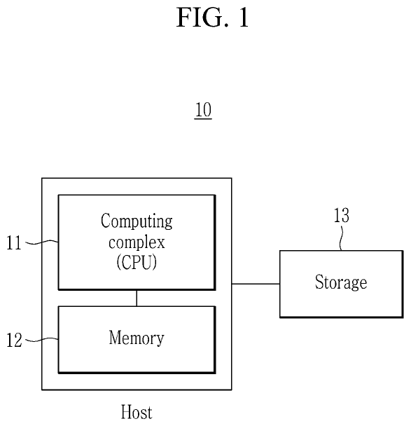

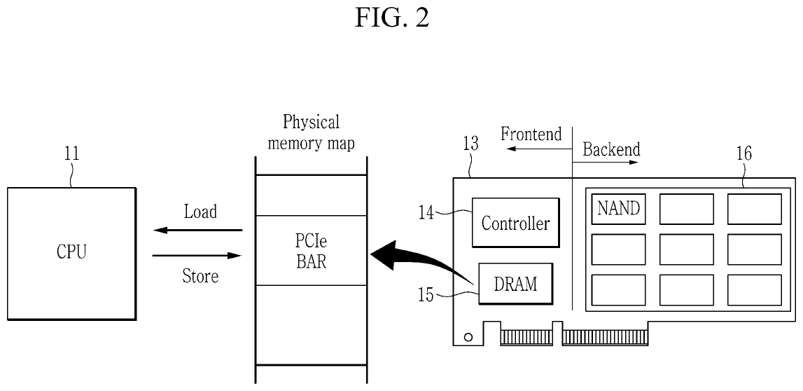

FIGS. 1 and 2 are diagrams illustrating a structure of a computing system according to an embodiment.

Referring to FIG. 1, a computing system 10 may include a computing complex 11, a memory 12, and a storage 13. The computing complex 11 may vary, for example, a central processing unit (CPU), a graphics processing unit (GPU), a microprocessor, or an application processor (AP), and in the description, the CPU will be described using an example.

The CPU 11 performs instructions to perform various operations (e.g., calculation, logic, control, input/output, etc.).

The memory 12 is system memory accessed and used by the CPU 11 and may include, for example, a DRAM. The CPU 11 and the memory 12 may be referred to as a host, and the memory 12 may be referred to as a host memory or a system memory.

The storage 13 may be connected to the host through the host interface. When a peripheral component interconnect express (PCIe) interface is used as the host interface, it may be called a PCIe storage. The host CPU 11 includes a root port (RP), and the RP may be connected to an end point (EP) of the storage 13. For example, the RP and the EP can be connected via the PCIe. Meanwhile, the storage 13 may be connected to the host through a network interface device.

Referring to FIG. 2, the storage 13 may be the block storage including a computing complex as a frontend and block media as a backend. The computing complex may include a controller 14, such as a CPU, and an internal memory (e.g., DRAM) 15. The backend block media 16 may include a flash memory-based memory module, for example, NAND flash. In order to hide slow latency of the backend block media 16, the internal memory 15 may be exposed and used in the form of a write-back cache of the backend block media. The computing complex may use non-volatile memory express (NVMe) protocol to access the backend block media.

When the storage 13 is the block storage such as the SSD, the storage 13 has a larger capacity than the DRAM or a persistent memory module (PMEM), and therefore, has the advantage of being a working memory for the host CPU connected to the PCIe. Therefore, the storage 13 may be used as a memory expander by providing byte-addressability, which may allow addresses to be specified in units of bytes.

The NVMe maps a memory space of the DRAM 15 to PCIe base address registers (BARs) to provide the byte-addressability. Since the BAR is directly mapped to a system memory space, the host CPU 11 may access the storage 13 using load/store instructions, like the internal memory.

However, since the PCIe recognizes the storage 13 as a peripheral device that should be managed and communicated with by the CXL-enabled CPU 11, a PCIe bandwidth is sufficient, but the PCIe has the limitation of being slow to be used in an actual system. This is because the storage 13 may process the load/store instructions of the host through the PCIe BAR, but may not use cache not to provide the same speed as the DRAM. In other words, since the BAR is only a host interface for communication between the CPU 11 and the DRAM 15, the CPU 11 should be manufactured to be directly accessible the load/store request without caching the load/store request.

When the CPU may cache/buffer a memory request targeting a PCIe address space, the request transmitted by the CPU may not be recognized by the storage 13, which may lead to unexpected situations such as system errors or storage disconnection. To prevent these errors, x86 instruction set architecture from Intel and AMD forces the CPU not to cache a PCIe-related memory request. Due to this non-cacheable characteristic, the memory of the PCIe storage is excluded from a memory hierarchy composed of the cache and local memory, and a user may not use the CPU cache. Accordingly, the non-cacheable characteristic seriously reduces access performance of all the memories targeting the BAR. As a result, the inability to cache the PCIe address space is essential for maintaining the system, but slows down the speed to hinder the use of the block storage as the memory expander.

In order to solve the problem of providing the PCIe BAR-based byte-addressability, the present disclosure describes a method of implementing the block storage as a cacheable memory expander by providing compute express link (CXL)-based byte-addressability. The CXL is an open industry standard that allows multiple heterogeneous devices to share the memory space through cache coherent interconnect.

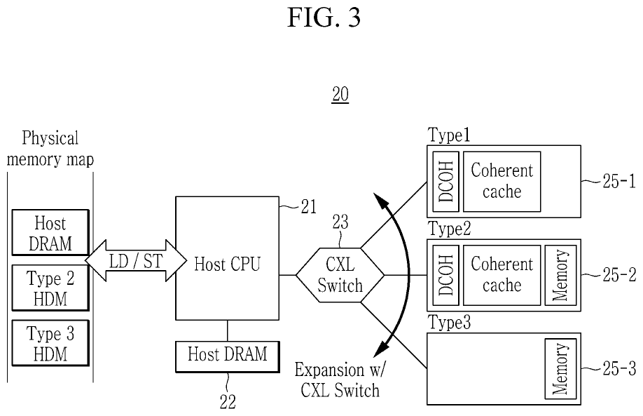

FIG. 3 is a diagram illustrating a structure of a CXL computing system according to an embodiment.

Referring to FIG. 3, a CXL-based computing system 20 may include a CXL-enabled CPU 21, a CXL switch 23, and CXL devices 25 (25-1, 25-2, and 25-3). The host may include the host CPU 21 and a host memory 22. The host memory may include the DRAM. The CXL switch 23 interconnects between the host CPU 21 and the CXL devices 25. The CXL devices 25 are nodes that provide a CXL protocol interface, and may be implemented by utilizing the design of existing peripheral devices, such as an accelerator or memory expander. The CXL-enabled CPU 21 has a space called a host physical address space (HPA space) or a physical memory map, and the local memory 22, the CXL device 25-2 having the internal memory, the CXL device 25-3, etc., may be mapped to the HPA space. Through the mapping, when the CXL-enabled CPU 21 makes a memory request for load/store to the HPA space (Type 2 HDM) to which the Type 2 CXL device 25-2 is mapped, the memory request may be transmitted to the CXL device 25-2.

The CXL supports three sub-protocols: CXL.io, CXL.cache, and the CXL.mem.

The CXL.io is an essential protocol for all types of hardware and is used for communication between the host and the CXL device. The CXL device may use the CXL.io to expose the device register to the HPA as a memory-mapped IO (MMIO). The CXL-enabled CPU 21 may use the CXL.io to discover the CXL device or configure necessary values.

The CXL.cache is a protocol used by CXL devices to implement a coherent cache by transmitting the memory request to the host. Using the CXL.cache, the CXL devices 25-1 and 25-2 may be included in a cache coherent domain, so data in the HPA space may be stored in the cache inside the device. According to the CXL 3.0, cache line states inside the CXL device are managed by a device coherency engine (DCOH). In addition, the CXL-enabled CPU 21 may have a cache coherency engine called a cache/home agent (CHA) embedded therein to place all the devices in the cache coherent domain managed by the CXL.

The CXL.mem is protocol for the host to access the memory by transmitting the memory request to the CXL device. Using the CXL.mem, the internal memory of the CXL devices 25-2 and 25-3 is a host-managed device memory (HDM), and may be exposed to the physical memory map of the host. The CXL-enabled CPU 21 may access the memory of the remote CXL devices 25-2 and 25-3 through the load/store instructions.

The CXL.io utilizes a layered communication layer of the PCIe called FlexBus which utilizes physical PCIe layers (transaction layer, data layer, and link layer) by converting the received CXL data into an appropriate format. On the other hand, the CXL.cache and the CXL.mem may add coherent cache and memory accessibility to the FlexBus to support multiple device domains and remote memory management.

Depending on a method of combining sub-protocols, the CXL devices 25 are classified into the Type 1 CXL device 25-1, the Type 2 CXL device 25-2, and the Type 3 CXL device 25-3.

The Type 1 CXL device 25-1 uses the CXL.io and CXL.cache for entire cache coherency functionality.

The Type 2 CXL device 25-2 is a device that uses the CXL.io, the CXL.cache, and the CXL.mem, and is an individual acceleration device that includes its own high-performance memory module. The host may basically communicate with the Type 2 CXL device using the CXL.io via the PCIe, and may implement coherent cache with the device and HDM access to the device using the CXL.cache and the CXL.mem. The host may manage the HDM using cache coherent load/store instructions.

The Type 3 CXL device 25-3 is a device that uses the CXL.io and the CXL.mem and may be used for a non-acceleration device that has no processing components and uses only the HDM managed by the host. Since the base memory write and read interface for the HDM is included in the CXL.mem, the Type 3 CXL device 25-3 does not use the CXL.cache, but may be used to expand the local memory of the host,

Among the various types of CXL devices, the Type 2 and Type 3 may be used as a storage-integrated memory expander. Here, the Type 2 device is designed for compute-intensive applications, and using the entire functionality of the CXL.cache and the CXL.mem provided by the Type 2 device, communication burden may occur and the overall performance of the storage-integrated memory expander may deteriorate. When integrating the PCIe storage into the CXL as the Type 2, the PCIe storage requests permission from the host each time it accesses its memory (e.g., NAND flash). This is because Type 2 CXL.cache manages both the local memory and HDM of the host in a completely coherent manner, which rather results in poor device-level I/O performance. Accordingly, in the present disclosure, a Type 3 device using the CXL.io and the CXL.mem may be described as the storage-integrated memory expander. Of course, it is also possible to implement the storage-integrated memory expander through the Type 2 device.

A CXL standard only considers the DRAM or PMEM for memory expansion, but may change the block interface of the PCIe storage to a byte interface such as memory through the CXL-based byte-addressability of the present disclosure. Multiple protocols of the CXL may integrate the PCIe storage into a cache coherent memory space, generating much larger memory pools than the existing memory expansion using only the DRAM or PMEM.

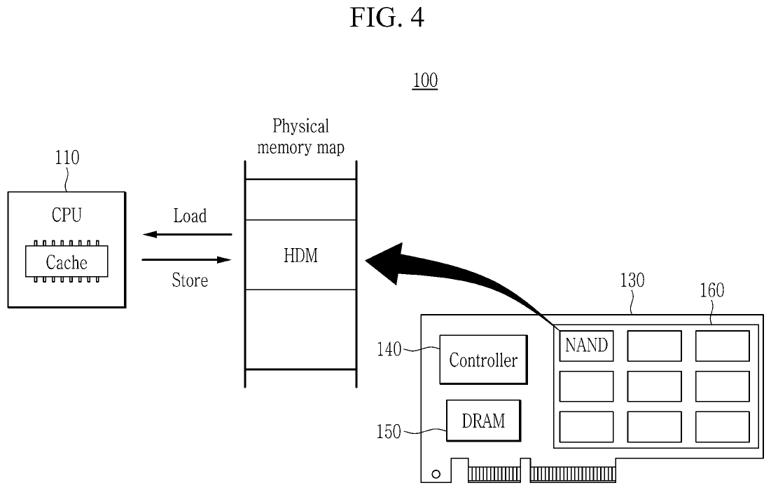

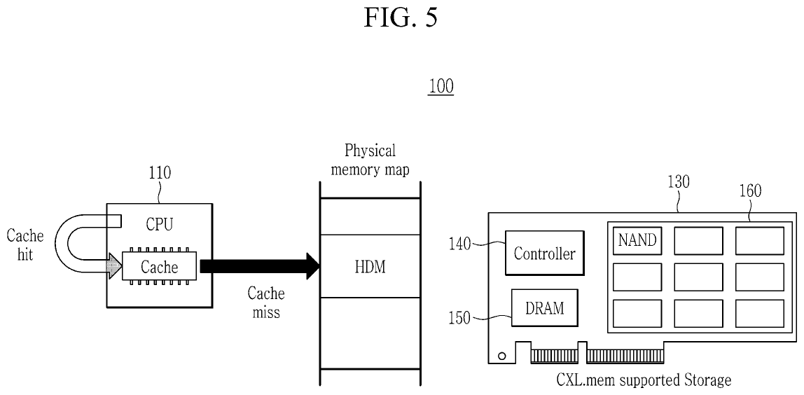

FIG. 4 is a diagram illustrating a computing system that provides a CXL-based byte-addressability according to an embodiment. FIG. 5 is a diagram for describing cacheable access according to an embodiment.

Referring to FIG. 4, a CXL computing system 100 may include a CXL-enabled CPU 110 and a CXL storage 130.

The CXL storage 130 may include a controller 140, an internal memory (e.g., DRAM) 150, and a flash memory-based memory module 160. The controller 140 may include a CXL controller and a memory controller. The CXL storage 130 may be implemented as SSD that supports the CXL.mem, for example, and may be called CXL-SSD. The memory module 160 may be, for example, NAND flash. The CXL storage 130 may be the Type 3 CXL device using the CXL.io and the CXL.mem.

The memory module 160 of the CXL storage 130 is the host-managed device memory (HDM) and may be mapped to the system physical memory map and exposed to the host. In this case, the HDM is mapped to a cacheable memory address space so that a user may access the HDM using the load/store instructions. Therefore, the HDM is included in the memory hierarchy of the CPU cache and local memory and may fully utilize the CPU cache of the host.

The CXL-enabled CPU 110 may access the flash memory of the CXL storage 130 through the load/store instructions. By providing the CXL-based byte-addressability, the CXL storage 130 may be used as the storage-integrated memory expander that may maintain cache coherency.

Memory resource information of the CXL storage 130 may be mapped to the system physical memory space of the host as follows. First, a bus within the CXL-enabled CPU 110 includes at least one RP, and the RP is connected to an EP of the CXL storage 130. In this case, the RP and the EP may be connected via the PCIe/FlexBus.

A kernel driver of the CXL-enabled CPU 110 collects the memory resource information of the CXL storage 130. The collected memory resource information may be mapped to the physical memory space reserved for CXL-based remote memory resources. Remote memory resource information includes a base address register size (BAR size) and a host-managed device memory size (HDM size), and may include memory identification information. The remote memory resource information may be managed in a configuration space of the CXL storage 130.

The kernel driver of the CXL-enabled CPU 110 maps the BAR and HDM of the CXL storage 130 to the physical memory space based on the collected memory resource information. The kernel driver informs the CXL storage 130 of the base address of the physical memory space where the BAR and HDM are mapped. Then, the CXL storage 130 stores the base addresses of the BAR and HDM in the configuration space.

Referring to FIG. 5, since the memory request for the HDM is cacheable, the CPU 110 may access the HDM through the internal cache. When there is no data in the cache memory within the CPU, that is, when a cache miss occurs, the CPU 110 reads data from the HDM connected to the CXL. In the case of the memory mapped to the existing the PCIe BAR, since the cache memory within the CPU may not be used, each time the memory of the PCIe storage is accessed, the memory should be accessed through the PCIe. On the other hand, as in the present disclosure, when using the CXL, the CPU 110 only needs to access the memory through the CXL only when there is no data in the cache, so the performance may be improved compared to the memory mapping through the PCIe BAR.

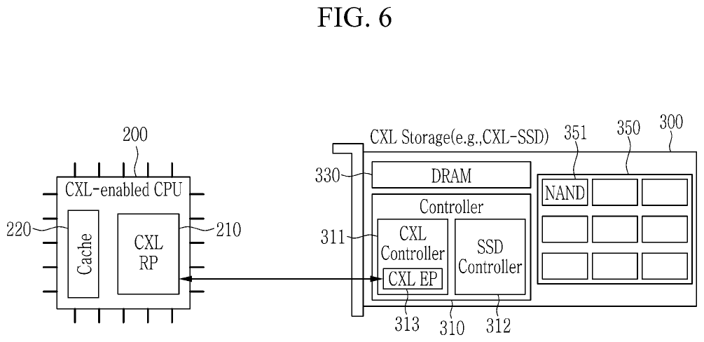

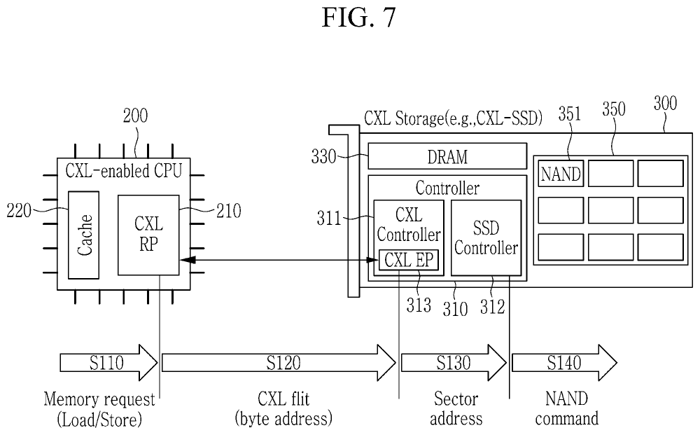

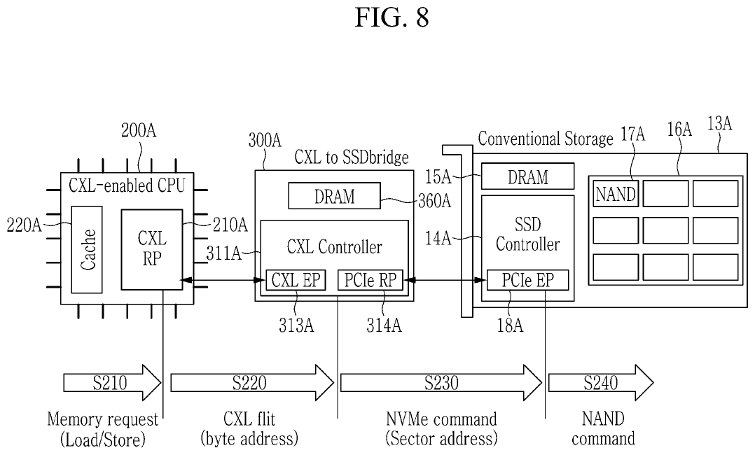

FIG. 6 is a diagram for describing a structure of a CXL-supported host device and CXL storage according to an embodiment. FIGS. 7 and 8 each are flow diagrams of a cacheable-based memory access method according to an embodiment.

Referring to FIG. 6, a host device (simply referred to as a host) 200 may include a CXL-enabled CPU that provides a CXL root port (CXL RP) 210. The CXL RP 210 may be implemented by adding a CXL packet (CXL flit) transmission function to a PCIe RP.

A CXL storage 300 may include a controller 310, an internal memory (DRAM) 330, and a flash memory-based memory module 350. The controller 310 may include a CXL controller 311 and a flash memory controller 312. For convenience of description, the flash memory controller 312 is called an SSD controller. The controller 310 may be generated by expanding the controller of the existing PCIe storage. The SSD controller 312 may include the SSD controller of the existing PCIe storage. The memory module 350 is described as including at least one flash memory (e.g., NAND flash) 351.

The CXL controller 311 may include a CXL EP 313. The CXL EP 313 may be implemented by adding the CXL packet transmission function to the PCIe EP. Through the CXL controller 311 using the existing PCIe EP logic, the CXL packet transmission and the storage control through the CXL.io may be performed. The memory request received by the CXL controller 311 from the host through the CXL.mem protocol is converted into a block (sector) unit request for the existing SSD and transmitted to the SSD controller 312. The SSD controller 312 executes firmware to manage the flash memory 351 and processes the block request transmitted by the CXL controller 311.

Meanwhile, the NVMe controller may implement the functions defined by the NVMe standard with firmware or hardware, but the reading/writing of the CXL.mem to be processed by the CXL controller 311 should be automated through hardware, and the firmware executed by the SSD controller 312 should be able to manage the internal DRAM and the backend block media (e.g., flash memory).

Next, a method for connecting the CXL storage 300 to the host and a method for directly accessing a host-side user/application to the CXL storage 300 through the load/store instructions will be described.

The system bus of the host includes the CXL RP, and the PCIe-based CXL storage is the Type 3 CXL device and connected to the CXL RP. When the host boots, the device is initialized by enumerating the CXL devices connected to the RP and mapping the internal memory space to the system memory. In particular, the host retrieves the sizes of the CXL BAR and HDM from the CXL storage and maps the CXL BAR and HDM to the system memory space reserved for the CXL RP. Here, the HDM is mapped to a cacheable memory address space so that a user may access the HDM using the load/store instructions. The CXL RP informs the CXL controller of the mapped location so that the CXL storage may understand an address (HPA) included in the memory request. To this end, the host may perform address space synchronization by recording the mapped location in the configuration space of the corresponding CXL storage.

Referring to FIG. 7, when a user performs a load/store memory request for the HDM, the host CPU checks whether there is data in an on-chip cache 220 for the memory request. When the cache miss occurs because there is no data in the cache 220, the on-chip cache 220 transmits the memory request to the CXL RP (S110).

The CXL RP 210 converts the memory request into the CXL flit and transmits the CXL flit to the CXL controller 311 which is the EP (S120). This CXL flit is the memory request for the Type 3 device, and therefore, may be transmitted through the CXL.mem.

The CXL controller 311 parses the CXL flit and converts the parsed CXL flit into the memory request, and converts the byte address of the memory request into a block address (sector address, LBA address) that the SSD controller 312 may understand (S130).

The SSD controller 312 uses this block address to access the flash memory 351 and transmits read/write commands to the flash memory 351 (S140). For example, when the request transmitted by the host is the load, the SSD controller 312 transmits a read command to the flash memory to copy the data stored in the flash memory to the internal memory 330. When the request transmitted by the host is the store, the SSD controller 312 stores the data transmitted by the CXL controller 311 in the internal memory 330 and then transmits write command to the flash memory 351 and records the write command in the flash memory.

Thereafter, the results processed by the SSD controller 312 are converted into the CXL flit by the CXL controller 311 and transmitted to the RP 210. The RP 210 may respond to the load/store instructions transmitted by the on-chip cache 220 of the host CPU.

Referring to FIG. 8, instead of the CXL storage 300 of FIG. 7, a CXL-SSD conversion device 300A (CXL to SSD bridge) may be used to connect the existing storage 13A using the existing block-based interface (PCIe, NVMe, SATA, SAS, etc.) to a CXL-supported host 200A. That is, the CXL storage 300 may be implemented separately as the CXL-SSD conversion device 300A and the existing storage 13A. Through this, the block storage such as the SSD that does not support the CXL may be used as the CXL memory expander. The CXL-SSD conversion device 300A may connect one or more SSDs to the host through the CXL.

As illustrated in FIG. 2, the existing storage 13A may be composed of an SSD controller 14A, an internal memory (DRAM) 15A, and a memory module 16A including at least one flash memory 17A, and the SSD controller 14A may include the block-based interface (e.g., the PCIe EP) 18A therein. As described in FIG. 2, the storage 13A using the interface (PCIe, NVMe, SATA, SAS, etc.) with the non-cacheable characteristic is not suitable for use as the memory expander. However, the CXL-SSD conversion device 300A may convert the communication protocol between the CXL-supported host 200 and the existing block-based interface, so the existing block storage may also be used as the memory expander.

The CXL support host 200A may include a CXL RP 210A, and an on-chip cache 220A. The CXL-SSD conversion device 300A may include a CXL controller 311A with a CXL EP 313A and an internal memory (DRAM) 360A therein. The CXL controller 311A may further include an interface 314A for communicating with the existing storage 13A. In this case, in the case of the PCIe/NVMe, the interface 314A may be the PCIe RP, and in the case of the SATA or SAS, may be a host bus adapter (HBA). The CXL-SSD conversion device 300A may convert the memory request of the host into storage request by converting the target memory address into the block address (sector address) and transmit the storage request to the existing storage 13A through the block-based interface.

The on-chip cache 220A of the host CPU transmits the memory request to the CXL RP 210A (S210). The CXL RP 210A converts the memory request into the CXL flit and transmits the CXL flit to the CXL controller 311A (S220).

The CXL controller 311A converts the CXL flit back into the memory request, converts the byte address of the memory request into the block address, and then uses the block address to convert into a command that the existing storage 13A may understand and transmits the command to the existing storage 13A (S230). For example, when the existing storage 13A is the NVMe device, the CXL controller 311A may transmit an NVMe command through the connected interface.

The SSD controller 14A of the existing storage 13A transmits the command received from the CXL controller 311A to the corresponding flash memory 17A (S240).

For example, when the request transmitted by the host is the load, the existing storage 13A records data read from the flash memory 17A to the internal memory 360A of the CXL-SSD conversion device 300A, and the CXL controller 311 converts the corresponding data into the CXL flit and responds to the host. Specifically, when the request transmitted by the host is the load instruction, the CXL controller 311A of the CXL-SSD conversion device 300A transmits the read command to the SSD controller 14A of the existing storage 13A. The SSD controller 14A transmits the read command to the flash memory 17A. When the flash memory 17A stores data in the internal memory (DRAM) 15A, the SSD controller 14A stores the data stored in the internal memory 15A in the internal memory 360A of the CXL-SSD conversion device 300A. The SSD controller 14A transmits an interrupt to the CXL controller 311A to inform that the request has been completed. Then, the CXL controller 311A converts the data stored in the internal memory 360A into the CXL flit and responds to the host.

When the request transmitted by the host is the store instruction, the CXL controller 311A of the CXL-SSD conversion device 300A stores the data received from the host in the internal memory 360A and then transmits the command to the SSD controller 14A. The SSD controller 14A reads the data stored in the internal memory 360A, copies the read data to its internal memory 15A, and transmits a write command to the flash memory 17A to write the data.

In the following, the CXL storage 300 is described as an example, but the operation of the CXL storage 300 may be performed by the CXL-SSD conversion device 300A and the existing storage 13A.

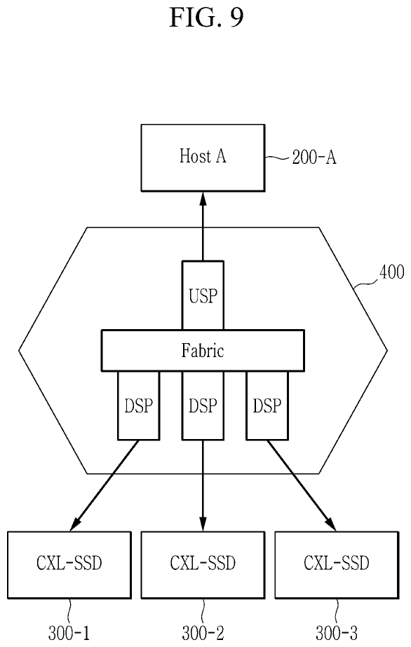

FIGS. 9 to 11 each are diagrams illustrating a storage distribution system according to an embodiment.

Referring to FIG. 9, CXL-supported host A 200-A may be interconnected with a plurality of CXL storages (the CXL-SSDs) 300-1, 300-2, and 300-3 through a CXL switch 400.

The CXL switch 400 may include a plurality of upstream ports (USP) and a plurality of downstream ports (DSP), and may route the incoming CXL flit according to an internal routing table. The CXL switch 400 may include a fabric manager FM that manages the internal routing table, and a switching unit that sets a crossbar between the USP and the DSP using the internal routing table.

The storage distribution system utilizing multiple SSDs may be implemented by connecting the USP to the RP of the host A 200-A through the CXL switch 400 and connecting the CXL storages 300-1, 300-2, and 300-3 to the DSP. The CXL flit may be transmitted between the host and the CXL storage through the connected ports.

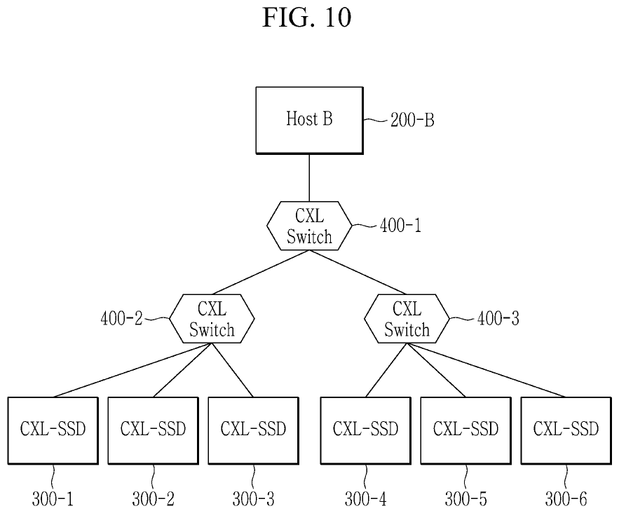

Referring to FIG. 10, a DSP of a CXL switch 400-1 may be connected to USP of lower CXL switches 400-2 and 400-3, and the USP of the lower CXL switches 400-2 and 400-3 may be connected to DSP of an upper CXL switch 400-1. Through the hierarchical switch connection, a host B 200-B may use the increased number of CXL storages 300-1 to 300-6 than a single CXL switch.

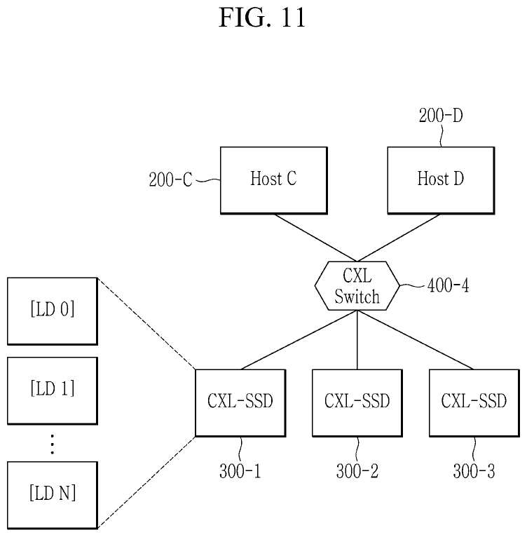

Referring to FIG. 11, a CXL switch 400-4 may support multiple hosts 200-C and 200-D. The CXL switch 400-4 may set the crossbar based on the routing table of the USP and the DSP, thereby allowing the host to use the mapped CXL storage.

In this case, when one host uses the entire CXL storage, resources will be used inefficiently. Therefore, the CXL storage 300-1 may be virtualized into multiple logical devices (MLD) LD 0, LD 1, . . . , LD N that divide the EP into a plurality of logical devices so that one device looks like multiple devices. Therefore, each logical device (LD) may be mapped to the system memory of the connected host as the HDM. By using the multiple logical devices virtualized by the multiple hosts, the multiple hosts may share one CXL storage.

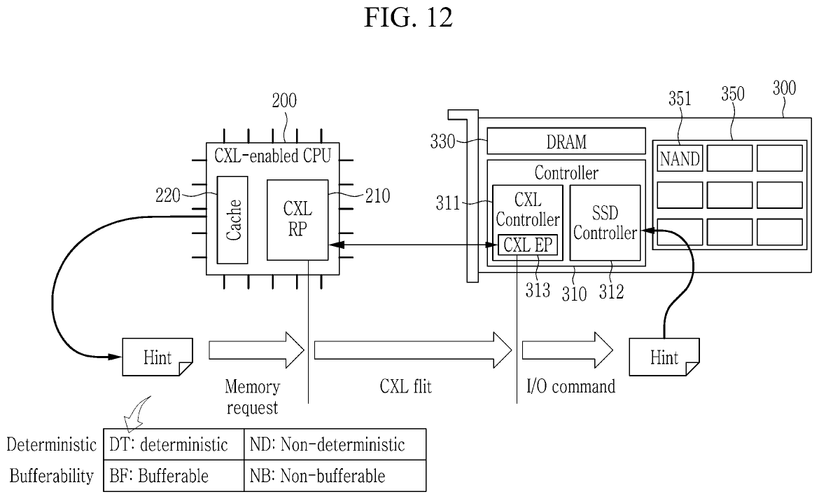

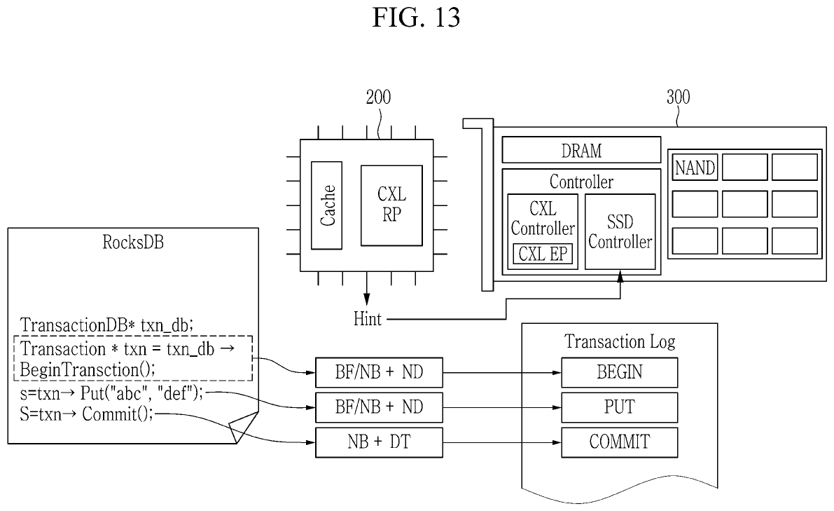

FIG. 12 is a diagram for describing a storage control method according to an embodiment. FIG. 13 is an example of storage control according to an embodiment.

Referring to FIG. 12, since the CXL memory request may be served asynchronously, the CXL.mem and the CXL.io protocol do not strictly manage the processing time of the load/store. Therefore, the request from the CXL storage to the host may be delayed. There are two reasons for this. First, the delay may occur due to the internal task of the CXL storage such as garbage collection and wear leveling. Second, in order to ensure data persistency required by a host-side library, when the data from the internal memory (DRAM) of the CXL storage should be written (flushed) to the flash memory, the latency may be long.

To resolve this delay, the host 200 transmits hints called determinism and bufferability along with the memory request to the CXL storage 300 or the CXL-SSD conversion device 300A. The hint may be included in the CXL message to provide additional information (semantics) on the memory request performed by the host to the SSD controller 312. The SSD controller 312 may operate according to the hint added to the memory request. The hint may be written in a reserved field of the CXL flit.

As illustrated in Table 1, the hint may be defined as the determinism and bufferability. The hint names named in Table 1 may be changed to other expressions. The determininism and bufferability may be used in various combinations depending on the situation, such as BF+DT, BF+ND, NB+DT, and NB+ND. Only one of the determinism or bufferability may be included in the hint. The state of either of the determinism or bufferability may not be determined, and only the other state may be determined. Alternatively, the default states of the determinism and bufferability may be defined for the memory request, and hints may be included only for requests that differ from the default state.

TABLE 1

| | |
|---|---|
| Type | State |

| | | |
|---|---|---|
| Determinism | Deterministic (DT) | Non- deterministic (ND) |
| Bufferability | Bufferable (BF) | Non-bufferable (NB) |

The determininism may be defined as two states: deterministic (DT) and non-deterministic (ND).

When a DT request including the DT arrives, the SSD controller 312 may delay other internal tasks and allow the DT request to be processed first. On the other hand, the ND request causes the corresponding request to be executed and then is made to be forgotten.

The bufferability may be defined as two states: bufferable (BF) and non-bufferable (NB). When the BF request arrives, the SSD controller 312 may cache or buffer the memory request in the internal memory 330. When the NB request arrives, an operation of ensuring the data persistency may be executed first. The CXL storage may optionally write requests back to block media, avoiding situations where all data is entirely written (flushed) to the block media at once.

Referring to FIG. 13, when beginning a RocksDB transaction, there is no need to have persistency because a commit of log does not occur, and the request processing is not urgent, so the bufferability is not specified in a transaction begin command (BF/NB) and include hints (BF/NB+ND) including the ND.

Since database query (PUT/GET) commands are also not urgent like a start command, the bufferability is not specified (BF/NB) and may include the hints (BF/NB+ND) including the ND.

Meanwhile, since the commit command should be written to the memory as quickly as possible to provide the persistency, the hints (NB+DT) including the NB and DT for the persistency may be included. The SSD controller that receives the hint including the NB may flush the data buffered in the internal memory (DRAM). The SSD controller that receives the DT hint may stop the internal task and first execute the input/output commands corresponding to the DT.

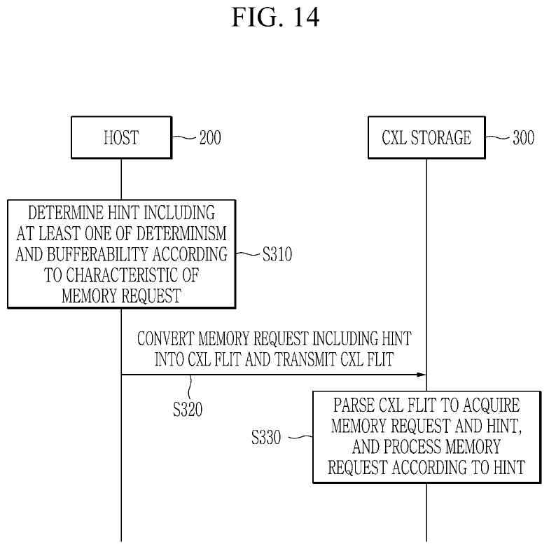

FIG. 14 is a flowchart of a storage control method according to the embodiment.

Referring to FIG. 14, the host 200 determines a hint including at least one of the determinism and bufferability according to the characteristics of the memory request (S310). The hint may be generated by combining the determinism and bufferability in Table 1. The DT request causes the CXL storage 300 to delay other internal tasks and first process the DT request. The BF request causes the CXL storage 300 to cache or buffer the memory request in the internal memory. Here, the host 200 includes the CXL-enabled CPU that provides the CXL RP, and the CXL RP may be implemented by adding the CXL packet transmission function to the PCIe RP. The CXL storage 300 may include the CXL controller 311, the SSD controller 312, the internal memory (DRAM) 330, and the flash memory-based memory module 350. The CXL storage 300 may be implemented as the Type 3 CXL device using the CXL.io and the CXL.mem. The CXL storage 300 may be the storage-based memory expander such as the SSD.

The host 200 converts the memory request including the hint into the CXL flit (CXL packet) and transmits the CXL flit to the CXL storage 300 (S320). The hint may be written in the reserved field of the CXL flit. The CXL RP of the host 200 may transmit the CXL flit to the CXL controller 311 which is the EP.

The CXL storage 300 parses the CXL flit to acquire the memory request and hint, and processes the memory request according to the hint (S330). When the CXL controller 311 of the CXL storage 300 parses the CXL flit to acquire the memory request and hint, and transmits the acquired memory request and hint to the SSD controller 312, the SSD controller 312 may operate according to the hint included in the request. For example, when the DT request arrives, the SSD controller 312 may delay other internal tasks and allow the DT request to be processed first. When the BF request arrives, the SSD controller 312 may cache or buffer the request in the internal memory 330. When the NB request arrives, by writing (flushing) the buffered data to the internal memory, the operation of ensuring the data persistency may be preferentially executed.

Meanwhile, the operation of the CXL storage 300 may change in design to be performed by the CXL-SSD conversion device 300A including the CXL controller 311A and the existing storage 13A including the SSD controller 14A.

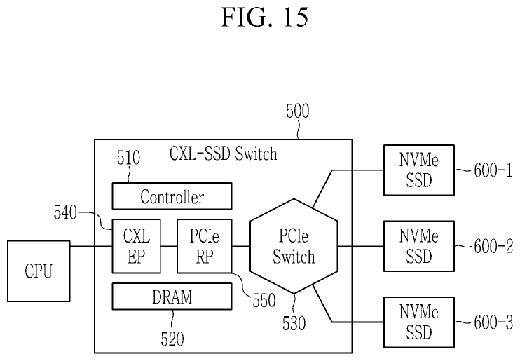

FIG. 15 is a diagram for describing a CXL-SSD switch according to an embodiment.

Referring to FIG. 15, a CXL-SSD switch 500 may connect one the CXL port to a plurality of SSDs 600-1, 600-2, and 600-3. To this end, the CXL-SSD switch 500 includes a controller 510, an internal memory (DRAM) 520, and a PCIe switch 530, and a CXL EP 540 is connected to a PCIe RP 550 and the PCIe RP 550) is connected to the PCIe switch 530.

The PCIe switch 530 routes the NVMe request generated by the controller 510 by converting the CXL flit to the NVMe SSD corresponding to the block address of the request.

The CXL-SSD switch 500 may alternately map contiguous memory space to multiple SSDs in units of one or more blocks (e.g., N×512B) in order to utilize all the input/output bandwidths of the SSDs. A unit of interleaving is determined by the controller 510, and may be set by the host CPU connected to the CXL-SSD switch 500 at the time of system booting. In other words, the CXL-SSD switch 500 may utilize SSD-level parallelism.

Since the CXL-SSD switch 500 has the single CXL EP 540, it is exposed to the host as a single CXL device. The capacity of the CXL device is equal to the sum of capacities of the SSDs 600-1, 600-2, and 600-3 connected to the CXL-SSD switch 500. The controller 510 of the CXL-SSD switch 500 may determine the capacities of each SSD at the time of initialization and then calculate the integrated CXL device capacity by adding the determined capacities. The controller 510 may determine the capacities of each SSD by reading the value stored in the PCIe configuration space of each SSD.

The CXL-SSD switch 500 may manage a plurality of NVMe queues in the internal memory 520 and may convert and transmit the CXL request to the NVMe request. The number of queues is equal to the number of SSDs connected to the CXL-SSD switch 500. For each NVMe queue, the controller 510 may maintain a list of the CXL requests routed to the corresponding queue, and when the CXL request is given, may determine an SSD identification number (ID) to transmit the request based on the physical address to which the request is directed. The controller 510 adds the CXL request to be processed to the list of the CXL requests associated with the identified SSD, converts the CXL request into an NVMe request, and transmits the NVMe request to the identified SSD. When the SSD completes the request processing and transmits the NVMe response to the CXL-SSD switch 500, the CXL-SSD switch 500 may process the NVMe request completion based on the NVMe queue in charge of the corresponding SSD, and find an original CXL request in the list of the CXL requests with the same identification number and then respond to the host.

The embodiment of the present disclosure described above is not implemented only through the device and method, and may be implemented through a program for realizing a function corresponding to the configuration of the embodiment of the present disclosure or a recording medium in which the program is recorded.

Although embodiments of the present disclosure have been described in detail hereinabove, the scope of the present disclosure is not limited thereto, but may include several modifications and alterations made by those skilled in the art using a basic concept of the present disclosure as defined in the claims.

What is claimed is:

1. A compute express link (CXL) computing system, comprising:
a host device including a CPU that supports CXL; and
a CXL storage connected to a CXL root port of the CPU based on the CXL interconnect and including a flash memory-based memory module.

2. The CXL computing system of claim 1, wherein the memory module is a host-managed device memory (HDM) and is mapped to a cacheable memory address space that is accessed by load/store instructions in the host device.

3. The CXL computing system of claim 2, wherein the CXL storage is a type 3 CXL device that supports CXL.io protocol and CXL.mem protocol.

4. The CXL computing system of claim 1, wherein the CXL root port includes a packet transmission function of CXL protocol.

5. The CXL computing system of claim 1, wherein the CXL storage includes a CXL controller, a flash memory controller, an internal memory, and the flash memory-based memory module.

6. The CXL computing system of claim 5, wherein the CXL controller includes a read/write interface of CXL.mem protocol.

7. The CXL computing system of claim 5, wherein the CXL controller is implemented in a conversion device separate from the storage including the flash memory controller and the memory module, and
the conversion device connects between the host device and the storage based on the CXL.

8. The CXL computing system of claim 1, wherein the host device and the CXL storage are connected through a CXL switch, and
the CXL switch routes CXL flits incoming to an upstream port or a downstream port to the corresponding port according to an internal routing table.

9. The CXL computing system of claim 1, wherein the host device accesses a host-managed device memory (HDM) through a cache, and when a cache miss occurs, converts a memory request into a CXL flit and transmits the CXL flit to the CXL storage.

10. The CXL computing system of claim 9, wherein the CXL flit includes a hint instructing the CXL storage to perform an operation related to the memory request.

11. A memory expander, comprising:
a compute express link (CXL) controller including an end point connected to a CXL root port based on a CXL and parsing a memory request from a received CXL flit,
a flash memory-based memory module, and
a flash memory controller controlling the memory module according to the memory request transmitted from the CXL controller.

12. The memory expander of claim 11, wherein the CXL controller supports CXL.io protocol and the CXL.mem protocol.

13. The memory expander of claim 12, wherein the CXL controller includes a read/write interface of the CXL.mem protocol.

14. The memory expander of claim 11, wherein the memory module is a host-managed device memory (HDM) and is mapped to a cacheable memory address space that is accessed by load/store instructions in a host.

15. The memory expander of claim 11, wherein the CXL flit includes a hint instructing an operation related to the memory request.

16. The memory expander of claim 15, wherein, when a request including a hint called deterministic (DT) arrives, the flash memory controller delays other internal tasks and first processes the corresponding request.

17. The memory expander of claim 15, wherein, when a request including a hint called bufferable (BF) arrives, the flash memory controller caches or buffers the corresponding request in an internal memory, and
when a request including a hint called non-bufferable (NB) arrives, the flash memory controller performs an operation of preferentially ensuring data persistency.

18. An operating method of a host device supporting a compute express link (CXL), comprising:
mapping a memory module of a CXL storage to a cacheable memory address space that is accessed by load/store instructions and managing the memory module as a host-managed device memory (HDM);
accessing the HDM through a cache for a memory request including the load/store instructions; and
converting the memory request into a CXL flit when a cache miss occurs and transmitting the CXL flit to the CXL storage.

19. The operating method of claim 18, wherein the CXL flit includes a hint instructing the CXL storage to perform an operation related to the memory request.

20. The operating method of claim 19, wherein the hint instructs to process the corresponding request before other internal tasks, instructs to cache or buffer the corresponding request in the internal memory of the CXL storage, or instructs to preferentially ensure data persistency for the corresponding request.
